(19) United States
(12) Patent Application Publication
(10) Pub. No.: US 2024/0365104 A1
(43) Pub. Date: Oct. 31, 2024

(54) METHOD AND APPARATUS FOR MANAGING EVENTS IN WIRELESS COMMUNICATION SYSTEM

(71) Applicant: Samsung Electronics Co., Ltd., Suwon-si (KR)

(72) Inventors: Jieun JUNG, Suwon-si (KR); Hyongjin BAN, Suwon-si (KR)

(21) Appl. No.: 18/612,247

(22) Filed: Mar. 21, 2024

Related U.S. Application Data
(63) Continuation of application No. PCT/KR2024/095114, filed on Feb. 14, 2024.

(30) Foreign Application Priority Data
Apr. 28, 2023 (KR) 10-2023-0056201
Aug. 9, 2023 (KR) 10-2023-0104036

(51) Int. Cl. H04W 8/18

(52) U.S. Cl. CPC H04W 8/183

(57) ABSTRACT

A server according to an embodiment includes: a communication circuit, a memory, and at least one processor, comprising processing circuitry, wherein at least one processor, individually and/or collectively, is configured to: receive information on a condition for forwarding an event from another subscription manager discovery server (SM-DS) and store the information in the memory, receive an event indicating that a profile has been prepared from a profile preparation server through the communication circuit, compare information on at least one of an eUICCidentifier (EID), a name of a service provider, an address of the profile preparation server, or a hashed integrated circuit card identifier (ICCID) stored in the memory, based on reception of the event, and determine whether to transmit the event indicating that the profile of the user has been prepared to the another subscription manager discovery server, based on the comparison.

### CROSS-REFERENCE TO RELATED APPLICATIONS

This application is a continuation of International Application No. PCT/KR2024/095114 designating the United States, filed on Feb. 14, 2024, in the Korean Intellectual Property Receiving Office and claiming priority to Korean Patent Application Nos. 10-2023-0056201, filed on Apr. 28, 2023, and 10-2023-0104036, filed on Aug. 9, 2023, in the Korean Intellectual Property Office, the disclosures of each of which are incorporated by reference herein in their entireties.

### BACKGROUND

### Field

The disclosure relates to an electronic device, for example, a method and an apparatus for managing many events in a wireless communication system.

### Description of Related Art

An electronic device may use a network provided by a mobile carrier to perform wireless communication. In order to use the network provided by the mobile carrier, the electronic device requires an authentication procedure between the network provided by the mobile carrier and the electronic device and may perform the authentication procedure with the network provided by the mobile carrier using a profile stored in the electronic device.

A profile preparation server (subscription manager data preparation+(SM-DP+)) may prepare an eSIM profile required for a new line service when a user subscribes to the new line. Further, the profile preparation server may generate an event mapped to a unique eUICC identifier (EID) of the electronic device to allow the electronic device to download the prepared eSIM profile. The generated event may be registered in a subscription manager discovery server (SM-DS) by the profile preparation server (SM-DP+). The electronic device may access the subscription manager discovery server (SM-DS) to check the registered event, identify the profile preparation server (SM-DP+), based on the registered event information, and download the eSIM profile prepared by the profile preparation server. Further, the subscription manager discovery server (SM-DS) may transmit the event to another SM-DP by a request from the profile preparation server (SM-DP+). According to cascading of events defined by the GSMA SGP.22 standard, an alternative SM-DS may transfer the event to another SM-DS by the request from the profile preparation server (SM-DP+). The electronic device (for example, UE) may access the profile preparation server (SM-DP+) via the alternative SM-DS to download the profile even if accessing just a root SM-DS.

A scheme, in which a first subscription manager discovery server makes a new event, based on a search for and an indication of a profile preparation server and transmits the event to a second subscription manager discovery server, has a limitation in that a search time increases.

There is another limitation in that traffic of the profile preparation server and the first subscription manager discovery server increases.

When there are a plurality of relay servers, an electronic device has a limitation in that all relay servers should be searched for in order to receive event information for downloading a profile.

The technical subjects of the disclosure are not limited to the above mentioned technical subjects, and other technical subjects which are not mentioned may be clearly understood through the following descriptions by those skilled in the art to which the disclosure pertains.

### SUMMARY

A server, according to an example embodiment, includes: a communication circuit, a memory, and at least one processor, comprising processing circuitry, wherein at least one processor, individually and/or collectively, is configured to: receive information on a condition for forwarding an event from another subscription manager discovery server (SM-DS) and store the information in the memory, receive an event indicating that a profile has been prepared from a profile preparation server through the communication circuit, compare information on at least one of an eUICCidentifier (EID), a name of a service provider, an address of the profile preparation server, or a hashed integrated circuit card identifier (ICCID) stored in the memory, based on reception of the event, and determine whether to transmit the event indicating that the profile has been prepared to the another subscription manager discovery server, based on a comparison.

A method of operating a server includes: receiving information on a condition for forwarding an event from another subscription manager discovery server (SM-DS) and storing the information in the memory, receiving event indicating that a profile has been prepared from a profile preparation server through a communication circuit, comparing information on at least one of an eUICCidentifier (EID), a name of a service provider, an address of the profile preparation server, or a hashed integrated circuit card identifier (ICCID) stored in the memory, based on reception of the event, and determining whether to transmit the event indicating that the profile has been prepared to the another subscription manager discovery server, based on a comparison.

A method and an apparatus for managing an event in a wireless communication system according to various example embodiments of the disclosure can reduce unnecessary traffic by transmitting an event between a plurality of relay servers (for example, a first subscription manager discovery server and a second subscription manager discovery server) without any search for a profile preparation server.

Further, a method and an apparatus for managing an event in a wireless communication system according to various example embodiments of the disclosure can reduce an event search time of the electronic device even in a situation in which it is difficult to perform interworking with the profile preparation server.

The effects that can be realized by the disclosure are not limited to the above-described effects, and other effects that have not been mentioned may be clearly understood by those skilled in the art from the following description.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram illustrating an example electronic device within a network environment according to various embodiments;

FIG. 2 is a diagram illustrating an example of connections between an electronic device, a subscription manager discovery server, a profile provision server, and a service provider according to various embodiments;

FIG. 3 is a block diagram illustrating an example configuration of a wireless communication system according to various embodiments;

FIG. 4 is a signal flow diagram illustrating an example method of managing an event in a wireless communication system in units of operations according to various embodiments; and

FIG. 5 is a flowchart illustrating an example method of managing an event in a wireless communication system according to various embodiments.

### DETAILED DESCRIPTION

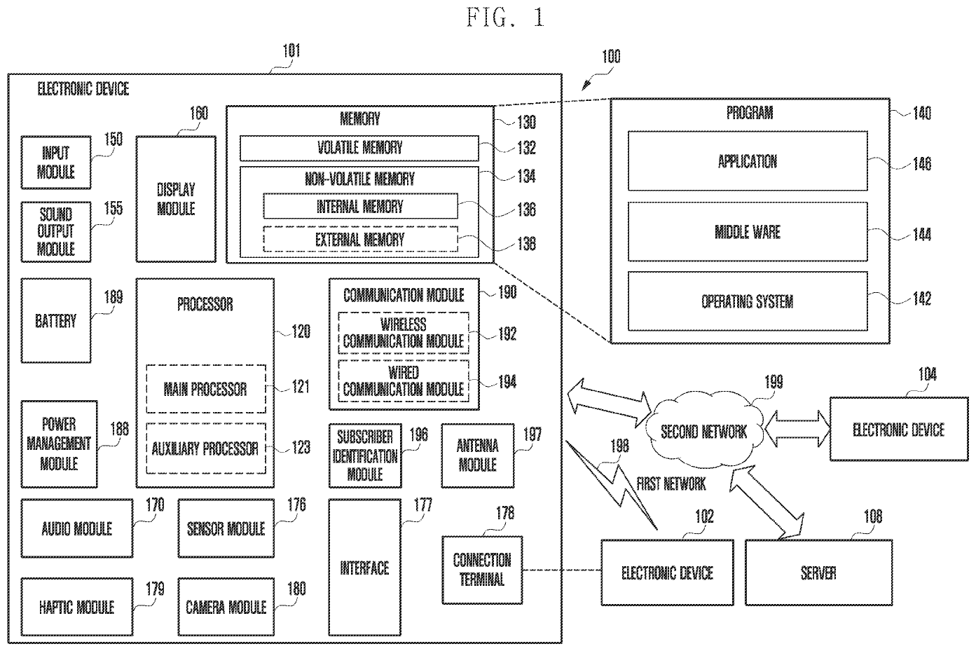

FIG. 1 is a block diagram illustrating an example electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In various embodiments, at least one of the components (e.g., the connecting terminal 178) may be omitted from the electronic device 101, or one or more other components may be added in the electronic device 101. In various embodiments, some of the components (e.g., the sensor module 176, the camera module 180, or the antenna module 197) may be implemented as a single component (e.g., the display module 160).

The processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™ wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

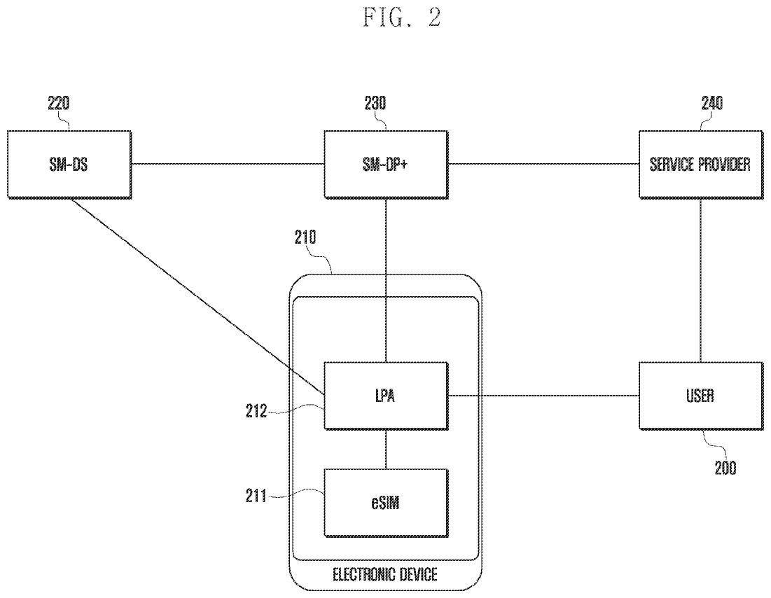

FIG. 2 is a diagram illustrating an example of the connection between an electronic device, a subscription manager discovery server, a profile preparation server, and a service provider according to various embodiments.

As illustrated in FIG. 2, an embedded subscriber identification module (eSIM) 211 (for example, the subscriber identification module 196 of FIG. 1) may be installed in an electronic device 210 (for example, the electronic device 101 of FIG. 1), and a profile (not shown) may be installed in the embedded subscriber identification module (eSIM) 211. Further, a local profile assistant (LPA) (e.g., including various circuitry and/or executable program instructions) 212 may be installed in the electronic device 210. The eSIM 211 may be controlled by the LPA 212. A user 200 may install the profile in the eSIM 211 of the electronic device 210 through the LPA 212 or control the installed profile.

The user 200 may receive a communication service from a service provider 240 (for example, a telecommunications operator or an operator). To this end, a profile of the service provider 240 may be installed in the electronic device 210.

The service provider 240 may be connected to a profile preparation server (subscription manager data preparation+(SM-DP+)) 230, and the LPA 212 of the electronic device 210 may access or interwork with the profile preparation server 230 and a subscription manager discovery server (SM-DS) 220. Although FIG. 2 illustrates the case in which each of the profile preparation server 230 and the subscription manager discovery server 220 are configured as a single server, one or more profile preparation servers (SM-DP+) may be included in the server configuration and one or more subscription manager discovery servers (SM-DSs) which assist in making the connection between a specific profile preparation server (for example, the profile preparation server 230) and the electronic device 210 may be included in the server configuration. As described above, it should be noted that various server configurations can be briefly expressed as a single profile preparation server.

Example operations and an event exchange procedure of the user 200, the electronic device 210, the eSIM 211, the LPA 212, the subscription manager discovery server 220, the profile preparation server 230, and the service provider 240 are described in greater detail below with reference to the drawings.

An address (fully qualified domain name (FQDN), IP address, or uniform resource locator (URL)) of the subscription manager discovery server 220 may be stored in the electronic device 210, the LAP 221, or the eSIM 211.

As illustrated in FIG. 2, the subscription manager discovery server may be connected to the profile preparation server 230. For example, the profile preparation server 230 may generate a specific event and register the generation of the corresponding event in the subscription manager discovery server 220.

Information which the profile preparation server 230 provides to the subscription manager discovery server 220 to register the generation of the event may include at least one of a forwarding indicator, an address (for example, FQDN) of the profile preparation server 230, a unique object identifier (for example, object ID (OID)) of the profile preparation server 230, an IP address of the profile preparation server 230, an event identifier (for example, EventID or MatchingID) generated by the profile preparation server 230, an eSIM identifier (hereinafter, referred to as an eUICC identifier or an EID) at which the event generated by the profile preparation server 230 aims, an identifier (EventCheckingSupport) indicating whether the corresponding event can be checked, or an event check identifier (for example, event checking ID (ECID)) connected to the eUICC identifier to be used when the event is checked.

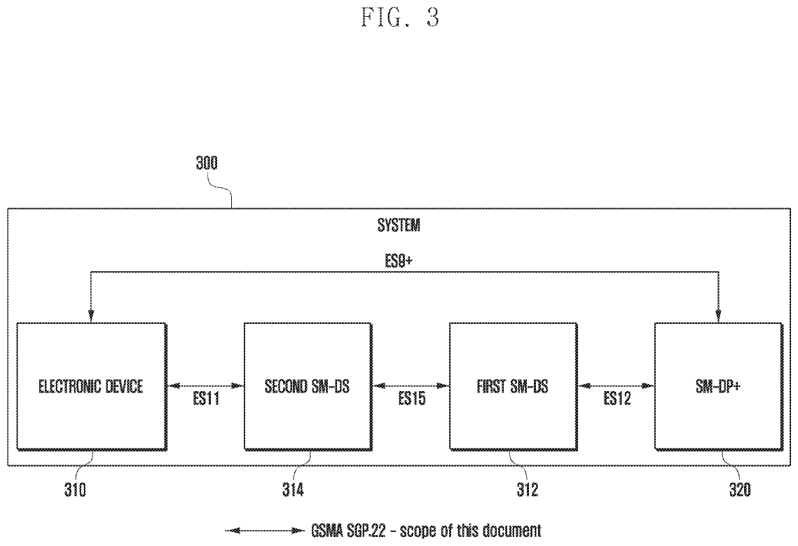

FIG. 3 is a block diagram illustrating an example configuration of a wireless communication system according to various embodiments.

According to FIG. 3, a system 300 may include an electronic device 310 (for example, the electronic device 101 of FIG. 1), a first subscription manager discovery server 312, a second subscription manager discovery server 314, and a profile preparation server 320 (for example, the profile preparation server 230 of FIG. 2).

ES9+, ES11, ES12, and ES15 may be communication schemes between the server and the device. The electronic device 310 may include, for example, a UE. The electronic device 310 may establish a communication connection with the second subscription manager discovery server 314 and exchange an event through the ES11 scheme. The second subscription manager discovery server 314 may be a root SM-DS directly accessed by the electronic device 310 or found through information of the electronic device 310.

The profile preparation server 320 may include a server that generates and manages a profile of the user. The profile preparation server 320 may generate the profile of the user, based on a profile request from a service provider (for example, the service provider 240 of FIG. 2), generate a corresponding event, and register the event in a relay server (for example, the first subscription manager discovery server 312). The first subscription manager discovery server 312 in which the event is registered may transmit the event to another subscription manager discovery server (for example, the second subscription manager discovery server 314).

The first subscription manager discovery server 312 may transfer an event indicating that the profile of the user has been prepared to the second subscription manager discovery server 314 in the state the first subscription manager discovery server 312 is not directly connected to the electronic device 310. For example, the event indicating that the profile of the user has been prepared may be transmitted from the first subscription manager discovery server 312 to the electronic device 310 via the second subscription manager discovery server 314. The first subscription manager discovery server 312 may be an alternative SM-DS. The second subscription manager discovery server 314 may be a root SM-DS.

The profile preparation server 320 may map information indicating that the profile has been prepared to the corresponding event, based on preparation of the profile. The profile preparation server 320 may transmit the event to which the information indicating that the profile has been prepared is mapped to the first subscription manager discovery server 312.

The first subscription manager discovery server 312 may transmit the event to which the information indicating that the profile has been prepared is mapped to the second subscription manager discovery server 314. The electronic device 310 may attempt access to the profile preparation server 320, based on the information on the event prepared by the second subscription manager discovery server 314. The information on the event may include an event ID and an address of the profile preparation server 320. The electronic device 310 may download the profile of the user using the profile preparation server 320.

The first subscription manager discovery server 312 may have difficulty in transmitting the event to another subscription manager discovery server (for example, the second subscription manager discovery server 314) without any request from the profile preparation server 320. In this case, subscription manager discovery servers which do not interwork with the profile preparation server 320 may have difficulty in receiving the event. Further, when the profile preparation server 320 does not support a function of making a request for transmitting the event between subscription manager discovery servers but there are a plurality of subscription manager discovery servers, there is a limitation in that the electronic device 310 should search for all relay servers in order to receive event information for downloading the profile of the user.

A method and an apparatus for managing an event in a wireless communication system according to an embodiment of the disclosure may reduce unnecessary traffic by transferring an event between a plurality of relay servers (for example, the first subscription manager discovery server 312 and the second subscription manager discovery server 314) without any request from the profile preparation server 320. Further, a method and an apparatus for managing an event in a wireless communication system according to an embodiment of the disclosure may reduce an event search time of the electronic device 310 even in a situation in which the profile preparation server 320 does not provide verification.

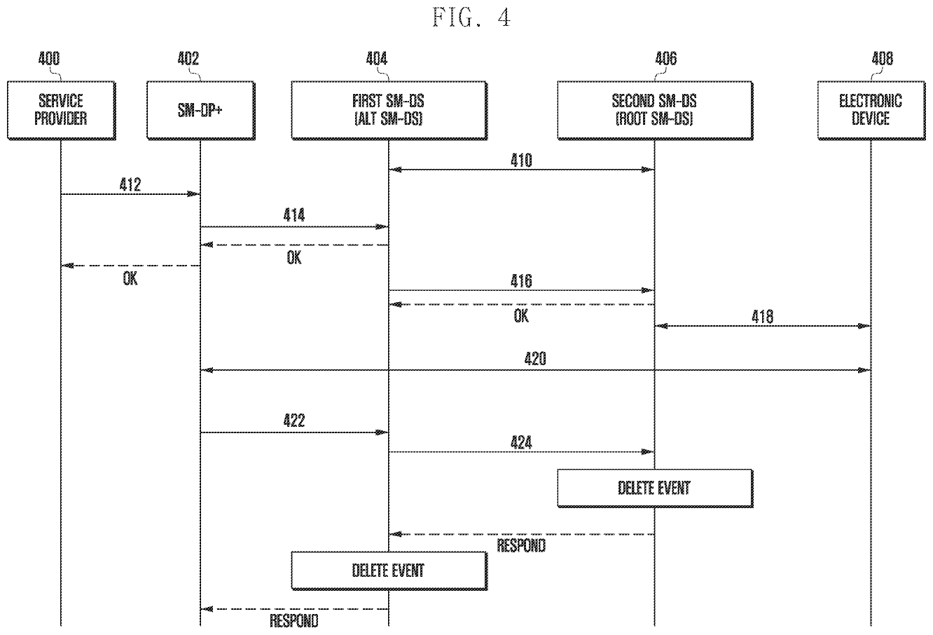

FIG. 4 is a signal flow diagram illustrating an example method of managing an event in a wireless communication system in units of operations according to various embodiments.

Some of the sequences of the operations in FIG. 4 may be changed, some operations may be omitted, and some operations may be simultaneously performed.

The wireless communication system according to the disclosure may include a service provider 400 (for example, the service provider 240 of FIG. 2), a profile preparation server 402 (for example, the profile preparation server 230 of FIG. 2), a first subscription manager discovery server 404 (for example the first subscription manager discovery server 312 of FIG. 3), a second subscription manager discovery server 406 (for example, the second subscription manager discovery server 314 of FIG. 3), and an electronic device 408 (for example, the electronic device 310 of FIG. 3).

The connection relationship and the roles of the service provider 400, the profile preparation server 402, the first subscription manager discovery server 404, the second subscription manager discovery server 406, and the electronic device 408 have been described in detail above with reference to FIG. 3.

In operation 410, a plurality of subscription manager discovery servers (for example, the first subscription manager discovery server 404 and the second subscription manager discovery server 406) may make a request for transmitting an event registered in the profile preparation server 402. For example, the second subscription manager discovery server 406 may make a request for transmitting an event registered in the profile preparation server 402 to the first subscription manager discovery server 404. When the second subscription manager discovery server 406 makes a request for transmitting an event to the first subscription manager discovery server 404, at least one of an address of the profile preparation server 402, a name of a service provider, or an eUICC identifier (EID) list may also be transmitted. Information on at least one of the address of the profile preparation server 402, the name of the service provider, or the eUICC identifier (EID) list may be transmitted and registered through a parameter using an application programming interface (for example, ES15.RegisterForwardingEvent) separately defined between the subscription manager discovery servers. The request for transmitting the event may transfer preset event forwarding parameters to the second subscription manager discovery server 406 not only online but also offline.

According to an embodiment, a processor (for example, the processor 120 of FIG. 1) of the first subscription manager discovery server 404 may compare the event received from the profile preparation server 402 with a forwarding condition registered in the second subscription manager discovery server 406 and determine whether to transmit the event received from the profile preparation server 402 to the second subscription manager discovery server 406.

For example, when the request for transmitting the event which the second subscription manager discovery server 406 registered in the first subscription manager discovery server 404 includes the address of the subscription manager discovery server 402, the first subscription manager discovery server 404 may transfer only an event received from the address of the specific profile preparation server 402 to the second subscription manager discovery server 406.

For example, when the request for transmitting the event for which the second subscription manager discovery server 406 made to the first subscription manager discovery server 404 includes the name of the service provider, the first subscription manager discovery server 404 may transfers only an event registered as the name of the specific service provider to the second subscription manager discovery server 406.

For example, when the request for transmitting the event for which the second subscription manager discovery server 406 made to the first subscription manager discovery server 404 includes the eUICC identifier (EID) list, the first subscription manager discovery server 404 may transfer only an event registered in the electronic device included in the eUICC identifier (EID) list to the second subscription manager discovery server 406.

According to an embodiment, when the second subscription manager discovery server 406 makes a request for transmitting the event to the first subscription manager discovery server 404, data related to the event transmission may be omitted. For example, the first subscription manager discovery server 404 may determine to transmit all of the registered events to the second subscription manager discovery server 406, based on omission of the address of the profile preparation server 402, the name of the service provider, or data on the eUICC identifier (EID).

The first subscription manager discovery server 404 may store an address of the second subscription manager discovery server 406 and data related to event transmission (for example, the address of the profile preparation server 402, the name of the service provider, and the eUICC identifier (EID) list) in the memory 130 in order to process the event transmission request. Thereafter, when receiving a registration event from the profile preparation server 402, the first subscription manager discovery server 404 may compare the registration event with information stored in the memory 130 and determine whether to transfer the received event to the second subscription manager discovery server 406.

According to an embodiment, the first subscription manager discovery server 404 may reject the event transmission request from the second subscription manager discovery server 406, based on mismatching between the information stored in the memory 130 and the information on the registered event received from the profile preparation server 402.

For example, the processor of the first subscription manager discovery server 404 may acquire address information of the profile preparation server 402 from the event received from the profile preparation server 402. The processor of the first subscription manager discovery server 404 may receive an event including the event transmission request from the second subscription manager discovery server 406. The processor of the first subscription manager discovery server 404 may compare the received event with the address of the profile preparation server 402 and determine whether to transmit the event to the second subscription manager discovery server 406.

In operation 412, the service provider 400 may a request for generating a profile of the user to the profile preparation server 402. The service provider 400 may transmit a profile generation request signal through a specific API (for example, ES2+.ConfirmOrder). The profile preparation server 402 may generate and manage the profile of the user, based on the request from the service provider 400. The service provider 400 may perform control to generate an eSIM profile to be used for the corresponding EID by transmitting the EID value to the profile preparation server 402.

In operation 414, the profile preparation server 402 may generate the corresponding event, based on the generation of the profile of the user and register the event in the first subscription manager discovery server 404 interworking with itself. The profile preparation server 402 may transfer the event through a specific communication method (for example, ES12.RegisterEvent).

The first subscription manager discovery server 404 receiving the event may store information related to the corresponding event. The event-related information may include one of an EID of the electronic device, an address of the profile preparation server 402, an ID of the event, a name of the service provider 400, or hashed ICCID.

When a push notification is supported, the first subscription manager discovery server 404 may specify the electronic device using the EID and transmit an event preparation status to the specified electronic device. Further, the first subscription manager discovery server 404 may identify whether the event request overlaps using the event ID, the address of the profile preparation server 402, and/or the name of the service provider 400.

The event-related information may be transferred to the specific electronic device (for example, the electronic device 408) and used for the following purposes. The electronic device 408 may download the profile by accessing the profile preparation server 402 receiving the profile. The electronic device 408 may identify whether the same event is received using the received event ID. The electronic device 408 may display information on an operator transmitting the event using the received name of the service provider 400. The electronic device 408 may identify whether the event is an event for the already installed profile using the received hashed ICCID.

When transmission of the second event is completed, the profile preparation server 402 may receive a notification indicating whether the transmission is completed from the first subscription manager discovery server 404. The profile preparation server 402 may receive the notification indicating that transmission of the second event is completed and transfer the received notification to the service provider 400. In operation 414, the communication connection may, for example, be made by ES12.

In operation 416, the first subscription manager discovery server 404 may determine whether to transmit the event to the second subscription manager discovery server 406. The first subscription manager discovery server 404 may compare information on the received event with information stored in the memory and determine whether to transmit the event to the second subscription manager discovery server 406, based on the comparison result.

When registration of the event from the profile preparation server 402 is completed, the first subscription manager discovery server 404 may compare the event with information stored in the memory 130 and determine whether to transmit the registered event to the second subscription manager discovery server 406.

For example, the first subscription manager discovery server404 may receive data (or event) related to the event transmission request from the second subscription manager discovery server 406. When the data related to the event transmission request includes the address of the profile preparation server 402, the first subscription manager discovery server 404 may compare the address with the address of the profile preparation server 402 stored in the memory 130 and determine whether to make the event transmission request to the second subscription manager discovery server 406.

For example, when the data related to the event transmission request includes the name of the service provider 400, the first subscription manager discovery server 404 may compare the name with the name of the service provider 400 stored in the memory 130 and determine whether to make the event transmission request to the second subscription manager discovery server 406.

For example, when the data related to the event transmission request includes the EID, the first subscription manager discovery server 404 may compare the EID with the EID stored in the memory 130 and determine whether to make the event transmission request to the second subscription manager discovery server 406.

When only the address of the second subscription manager discovery server 406 is registered in the data related to the event transmission request, the first subscription manager discovery server 404 may transfer all events to the address of the second subscription manager discovery server 406. The first subscription manager discovery server 404 may transfer the event through a specific API (for example, ES15.RegisterEvent). The first subscription manager discovery server 404 may transmit information on the event received from the profile preparation server 402 to the second subscription manager discovery server 406.

According to an embodiment, the first subscription manager discovery server 404 may receive the event from the profile preparation server 402. The first subscription manager discovery server 404 may store a condition for forwarding a specific event between subscription manager discovery servers in the memory. The event may include information indicating the profile has been prepared. The profile may be used to identify the electronic device 408. The electronic device 408 may include a specific eUICC chip identified by an EID value.

Table 1 shows data related to transmission of an event included in the event.

TABLE 1

| Data Name | Type | Sample |
|---|---|---|
| Profile preparation server | FQDN | http://www.smdp.sam.com |
| (SM-DP+) | | |
| Event ID | String | DGEF89KKEHC2334 |
| Service provider name | String | Sam |
| EID | String | 890430512033211234245632456754 |
| Hashed ICCID | String | 12alghek345akfhd |

Table 2 shows data related to a condition for transmitting the event stored in the first subscription manager discovery server 404.

TABLE 2

| Data Name | Type | Sample |
|---|---|---|
| Second subscription manager | FQDN | http://www.smds.sam.com |
| discovery server (Root SM-DS) | | |
| Profile preparation server (SM-DP+) | FQDN | http://www.smdp.sam.com |
| Service provider | String | — |
| EID | String | — |

The processor of the first subscription manager discovery server 404 may compare the address of the profile preparation server (SM-DP+) 402 with the address of the profile preparation server (SM-DP+) 402 included in the event and determine whether to transmit the event. The processor of the first subscription manager discovery server 404 may transmit an event indicating that the profile of the user has been prepared to the second subscription manager discovery server 406, based on matching between the address of the subscription manager discovery server 402 stored in the memory 130 and the address of the subscription manager discovery server 402 in the event.

In comparison between Table 1 and Table 2, it may be identified that the addresses of the profile preparation server are all http://www.smdp.sam.com. The address of the profile preparation server is only an address but is not limited thereto.

For example, the first subscription manager discovery server 404 may receive the event from the profile preparation server 402. The event may include data related to event transmission. Table 3 shows data related to event transmission.

TABLE 3

| Data Name | Type | Sample |
|---|---|---|
| Profile preparation server | FQDN | http://www.smdp.mnd.com |
| (SM-DP+) | | |
| Event ID | String | DGEF89KKEHC2334 |
| Service provider | String | Oh |
| EID | String | 890430512033211234245632456754 |
| Hashed ICCID | String | 12alghek345akfhd |

The address of the profile preparation server 402 shown in Table 3 is http://www.smdp.mnd.com, and the address of the profile preparation server 402 shown in Table 2 is http://www.smdp.sam.com. In comparison between Table 3 and Table 2, it may be identified that addresses of the profile preparation server are different.

The processor of the first subscription manager discovery server 404 may not transmit the event to the second subscription manager discovery server 406, based on mismatching between the addresses of the profile preparation server 402.

In operation 416, the first subscription manager discovery server 404 may transmit an event indicating that the profile of the user has been registered in the second subscription manager discovery server 406, based on matching between the address of the profile preparation server 402 stored in the first subscription manager discovery server 404 and the address of the profile preparation server 402 in the event received from the profile preparation server 402. In operation 416, the communication connection may be made through ES15. According to an embodiment, the first subscription manager discovery server 404 may receive a notification (for example, OK) indicating that transmission from the second subscription manager discovery server 406 is completed. According to an embodiment, the first subscription manager discovery server 404 may omit the notification (for example, OK) indicating that transmission from the second subscription manager discovery server 406 is completed.

In operation 418, the second subscription manager discovery server 406 may transmit the event received from the first subscription manager discovery server 404 to the electronic device 408. The electronic device 408 may identify the address of the profile preparation server 402, based on the received event.

The event received by the second subscription manager discovery server 406 may be directly transferred to the electronic device 408 through a push notification. The electronic device 408 may directly access the second subscription manager discovery server 406 to have the event. During such a process, information related to the event may be directly transferred to the electronic device 408 through a push notification. Alternatively, the electronic device 408 may acquire information related to the event by accessing the second subscription manager discovery server 406 through a separate application programming interface (API).

The information related to the event may include one of an EID of the electronic device, an address of the profile preparation server 402, an ID of the event, a name of the service provider 400, or hashed ICCID.

When the push notification is supported, the first subscription manager discovery server 404 may specify the electronic device (for example, the electronic device 408) using the EID and transmit an event preparation status to the specified electronic device. Further, the first subscription manager discovery server 404 may identify whether the event request overlaps using the event ID, the address of the profile preparation server 402, and/or the name of the service provider 400.

The information related to the event may be transferred to the specific electronic device (for example, the electronic device 408) and used for the following purposes. The electronic device 408 may download the profile by accessing the profile preparation server 402 receiving the profile. The electronic device 408 may identify whether the same event is received using the received event ID. The electronic device 408 may display information on an operator transmitting the event using the received name of the service provider 400. The electronic device 408 may identify whether the event is an event for the already installed profile using the received hashed ICCID.

In operation 420, the electronic device 408 may establish a communication connection with the profile preparation server 402, based on the address of the profile preparation server 402 identified in the received event. In operation 420, the communication connection may be made by a specific API (DP: ES9+). According to an embodiment, the electronic device 408 may make a request for a profile mapped to the event to the profile preparation server 402.

In operation 422, the profile preparation server 402 may transmit a signal making a request for deleting the event to the first subscription manager discovery server 404. The profile preparation server 402 may transmit an event deletion request signal through a specific API (for example, ES12.DeleteEvent). The first subscription manager discovery server 404 may delete the event, based on the signal making a request for deleting the event from the profile preparation server 402.

In operation 424, the first subscription manager discovery server 404 may transfer the signal making the request for deleting the event to the second subscription manager discovery server 406. The first subscription manager discovery server 404 may delete the event and transmit the event deletion request to the second subscription manager discovery server 406. Like the event registration request, the first subscription manager discovery server 404 may determine whether to transmit the event deletion request, based on at least one piece of information among the address of the profile preparation server 402, the name of the service provider 400, or the EID list. The second subscription manager discovery server 406 may delete the corresponding event, based on reception of the event deletion request from the first subscription manager discovery server 404.

According to an embodiment, the first subscription manager discovery server 404 may delete the registered event after receiving a signal indicating that the event has been deleted from the second subscription manager discovery server 406. The first subscription manager discovery server 404 may transmit a response signal indicating that the event has been deleted from the second subscription manager discovery server 406 to the profile preparation server 402.

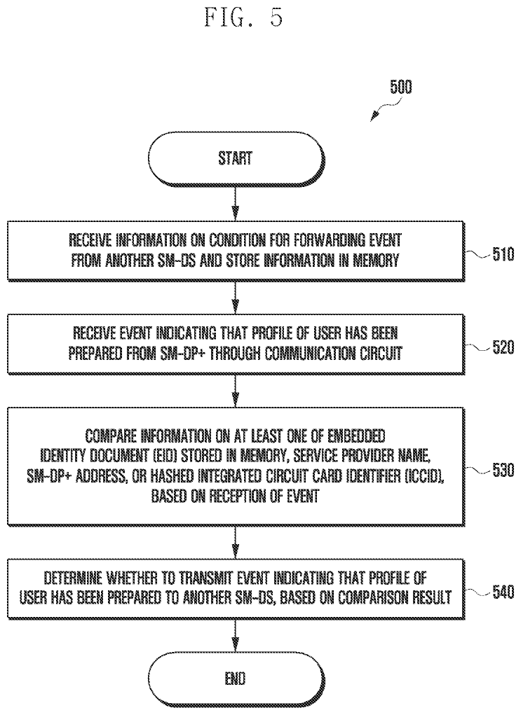

FIG. 5 is a flowchart illustrating an example method of managing an event in a wireless communication system according to various embodiments.

Operations described with reference to FIG. 5 may be implemented based on instructions which can be stored in a computer-readable medium or a memory (for example, the memory 130 of FIG. 1). The illustrated method 500 may be performed by the server (for example, the first subscription manager discovery server 404 of FIG. 4) described with reference to FIGS. 1 to 4, and the above-described technical features may not be repeated here. The sequences of the operations in FIG. 5 may be changed, some operations may be omitted, and some operations may be simultaneously performed.

In operation 510, the processor 120 may receive information on a condition for forwarding an event from another subscription manager discovery server (for example, the second subscription manager discovery server 406 of FIG. 4) and store the information in the memory 130. The condition for forwarding the event may include at least one of, for example, an eUICCidentifier (EID), a service provider, an address of the profile preparation server, or a hashed integrated circuit card identifier (ICCID).

In operation 520, the processor 120 may receive an event indicating that the profile of the user has been prepared from the profile preparation server (for example, the profile preparation server 402 of FIG. 4) through a communication circuit.

The profile preparation server 402 may generate and manage the profile of the user, based on a request from the service provider (for example, the service provider 400 of FIG. 4). The service provider 400 may transfer an EID value to the profile preparation server 402 and perform control to generate an eSIM profile to be used by the corresponding EID.

In operation 530, the processor 120 may compare information on at least one of the eUICCidentifier (EID), the service provider, the address of the SM-DP, or the hashed integrated circuit card identifier (ICCID) stored in the memory 130, based on reception of the event. The event may include information on at least one of the eUICCidentifier (EID), the name of the service provider 400, the address of the profile preparation server 402, or the hashed integrated circuit card identifier (ICCID).

When a push notification is supported, the first subscription manager discovery server 404 may specify the electronic device using the EID and transmit an event preparation status to the specified electronic device. Further, the first subscription manager discovery server 404 may identify whether the event request overlaps using the event ID, the address of the profile preparation server 402, and/or the name of the service provider 400.

The information related to the event may be transferred to the specific electronic device (for example, the electronic device 408) and used for the following purposes. The electronic device 408 may download the profile by accessing the profile preparation server 402 receiving the profile. The electronic device 408 may identify whether the same event is received using the received event ID. The electronic device 408 may display information on an operator transmitting the event using the received name of the service provider 400. The electronic device 408 may identify whether the event is an event for the already installed profile using the received hashed ICCID.

In operation 540, the processor 120 may determine whether to transmit an event indicating that the profile of the user has been prepared to the second subscription manager discovery server (for example, the second subscription manager discovery server 406 of FIG. 4), based on the comparison result.

According to an embodiment, the processor 120 may determine to transmit the event to the second subscription manager discovery server (for example, the second subscription manager discovery server 406), based on matching between the address of the profile preparation server 402 stored in the memory 130 and the address of the subscription manager discovery server 402 recorded in the event.

According to an embodiment, the processor 120 may delete the event stored in the memory 130, based on reception of an event deletion request from the profile preparation server 402 transmitting the event and transmit the event deletion request to the second subscription manager discovery server 406 transmitting the event.

According to an embodiment, the processor 120 may transmit the event deletion request to the second subscription manager discovery server 406 transmitting the event, based on reception of the event deletion request from the profile preparation server 402 transmitting the event and delete the event stored in the memory, based on reception of a response event of the event deletion request from the second subscription manager discovery server 406.

According to an embodiment, the processor 120 may determine to not transmit the event to the subscription manager discovery server, based on mismatching between the EID stored in the memory 130 and the EID in the event, mismatching between the address of the profile preparation server 402 stored in the memory 130 and the address of the profile preparation server 402 recorded in the event, and mismatching between information on the service provider stored in the memory 130 and information on the service provider recorded in the event.

According to an embodiment, the processor 120 may establish the communication connection with the profile preparation server 402, based on information on the profile preparation server in the event in the state in which the event is received.

According to an embodiment, the processor 120 may make a request for a profile mapped to the event to the profile preparation server 402.

Embodiments of the disclosure are specific examples presented to describe the technical content according to various example embodiments of the disclosure and to aid in understanding of the disclosure, and do not limit the scope of the disclosure. Accordingly, the scope of the disclosure should be understood such that all modifications or modified forms derived based on the technical idea of the disclosure as well as the embodiments described herein are included in the scope of the disclosure including the appended claims and their equivalents. It will also be understood that any of the embodiment(s) described herein may be used in conjunction with any other embodiment(s) described herein.

What is claimed is:

1. A server comprising:
a communication circuit;
a memory; and
at least one processor, comprising processing circuitry,
wherein at least one processor, individually and/or collectively, is configured to:
receive information on a condition for forwarding an event from another subscription manager discovery server (SM-DS) and store the information in the memory;
receive an event indicating that a profile has been prepared from a profile preparation server through the communication circuit;
compare information on at least one of an eUICCidentifier (EID), a name of a service provider, an address of the profile preparation server, or a hashed integrated circuit card identifier (ICCID) stored in the memory, based on reception of the event; and
determine whether to transmit the event indicating that the profile of the user has been prepared to the another subscription manager discovery server, based on the comparison.

2. The server of claim 1, wherein at least one processor, individually and/or collectively, is configured to determine transmission of the event to the subscription manager discovery server, based on matching between the address of the profile preparation server stored in the memory and the address of the profile preparation server recorded in the event.

3. The server of claim 1, wherein at least one processor, individually and/or collectively, is configured to determine transmission of the event to the subscription manager discovery server, based on matching between the EID stored in the memory and the EID in the event.

4. The server of claim 1, wherein at least one processor, individually and/or collectively, is configured to determine transmission of the event to the subscription manager discovery server, based on matching between information on the service provider stored in the memory and information on the service provider recorded in the event.

5. The server of claim 1, wherein at least one processor, individually and/or collectively, is configured to determine transmission of the event to the subscription manager discovery server, based on the address of the subscription manager discovery server described in the event.

6. The server of claim 1, wherein at least one processor, individually and/or collectively, is configured to:
delete the event stored in the memory, based on reception of an event deletion request from the profile preparation server transmitting the event; and
transmit the event deletion request to the subscription manager discovery server transmitting the event.

7. The server of claim 1, wherein at least one processor, individually and/or collectively, is configured to:
transmit the event deletion request to the subscription manager discovery server transmitting the event, based on reception of the event deletion request from the profile preparation server transmitting the event; and
delete the event stored in the memory, based on reception of a response event of the event deletion request from the subscription manager discovery server.

8. The server of claim 1, wherein at least one processor, individually and/or collectively, is configured to determine non-transmission of the event to the subscription manager discovery server, based on mismatching between the EDI stored in the memory and the EID in the event, mismatching between the address of the profile preparation server stored in the memory and the address of the profile preparation server recorded in the event, and mismatching between information on the service provider stored in the memory and information on the service provider recorded in the event.

9. The server of claim 1, wherein at least one processor, individually and/or collectively, is configured to establish a communication connection with the profile preparation server, based on information on the profile preparation server in the event in a state in which the event is received.

10. The server of claim 9, wherein at least one processor, individually and/or collectively, is configured to make a request for a profile mapped to the event to the profile preparation server.

11. A method of operating a server, the method comprising:
receiving information on a condition for forwarding an event from another subscription manager discovery server (SM-DS) and storing the information in the memory;
receiving event indicating that a profile has been prepared from a profile preparation server through a communication circuit;
comparing information on at least one of an eUICCidentifier (EID), a name of a service provider, an address of the profile preparation server, or a hashed integrated circuit card identifier (ICCID) stored in the memory, based on reception of the event; and
determining whether to transmit the event indicating that the profile of the user has been prepared to the another subscription manager discovery server, based on the comparison.

12. The method of claim 11, further comprising determining transmission of the event to the subscription manager discovery server, based on matching between the address of the profile preparation server stored in the memory and the address of the profile preparation server recorded in the event.

13. The method of claim 11, further comprising determining transmission of the event to the subscription manager discovery server, based on matching between the EID stored in the memory and the EID in the event.

14. The method of claim 11, further comprising determining transmission of the event to the subscription manager discovery server, based on matching between information on the service provider stored in the memory and information on the service provider recorded in the event.

15. The method of claim 11, further comprising determining transmission of the event to the subscription manager discovery server, based on the address of the subscription manager discovery server described in the event.

16. The method of claim 11, further comprising:
deleting the event stored in the memory, based on reception of an event deletion request from the profile preparation server transmitting the event; and
transmitting the event deletion request to the subscription manager discovery server transmitting the event.

17. The method of claim 11, further comprising:
transmitting the event deletion request to the subscription manager discovery server transmitting the event, based on reception of the event deletion request from the profile preparation server transmitting the event; and
deleting the event stored in the memory, based on reception of a response event of the event deletion request from the subscription manager discovery server.

18. The method of claim 11, further comprising determining non-transmission of the event to the subscription manager discovery server, based on mismatching between the EDI stored in the memory and the EID in the event, mismatching between the address of the profile preparation server stored in the memory and the address of the profile preparation server recorded in the event, and mismatching between information on the service provider stored in the memory and information on the service provider recorded in the event.

19. The method of claim 11, further comprising establishing a communication connection with the profile preparation server, based on information on the profile preparation server in the event in a state in which the event is received.

20. The method of claim 19, further comprising making a request for a profile mapped to the event to the profile preparation server.
